(19) United States
(12) Patent Application Publication
(10) Pub. No.: US 2004/0133494 A1
(43) Pub. Date: Jul. 8, 2004

(54) Method and Apparatus for Issuing a Unit

(75) Inventors: Emerson P. Jones, Greenwich, CT (US); Karen Schoen, New York, NY (US); Ivan Ross, Scarsdale, NY (US)

Correspondence Address: BUCKLEY, MASCHOFF, TALWALKAR LLC, 5 ELM STREET, NEW CANAAN, CT, 06840, US

(73) Assignee: Goldman Sachs, New York, NY (US)

(21) Appl. No.: 10/707,491

(22) Filed: Dec. 17, 2003

Related U.S. Application Data
(60) Provisional application No. 60/493,558, filed on Aug. 8, 2003.
(60) Provisional application No. 60/493,187, filed on Aug. 7, 2003.

(51) Int. Cl. G06F 17/60

(52) U.S. Cl. 705/35

(57) ABSTRACT

Systems, methods, apparatus, computer program code and means for issuing a unit to a holder are provided. The unit includes a forward contract and a note or preferred stock securing obligations of the holder under the forward contract. The note permits the holder to convert the note into an amount of shares of issuer stock pursuant to a conversion formula.

### BACKGROUND OF INVENTION

This application claims priority to, and hereby incorporates by reference for all purposes, U.S. Provisional Application Serial Nos. 60/493,558, and 60/493,187, filed Aug. 5, 2003 and Aug. 7, 2003 respectively.

The present invention relates to methods and apparatus for conducting transactions. More particularly, embodiments of the present invention relate to methods and apparatus for issuing a unit including a forward contract and a note or other instrument. For convenience, as used herein, the terms “convertible note” or “convertible debt” will be used to refer to convertible debt or convertible preferred stock.

Hybrid financial products involving the issuance of a stock purchase contract together with a debt instrument were first introduced in the mid to late-1990's, and have become popular products providing benefits to both issuers and investors. These hybrid financial products are commonly referred to as “mandatory units.” It would be desirable to provide mandatory units having improved financial benefits. It would further be desirable to provide improved methods and apparatus for conducting transactions that result in improved benefits to issuers.

### SUMMARY OF INVENTION

To alleviate problems inherent in the prior art, embodiments of the present invention provide systems, methods, apparatus, computer program code and means for issuing a note to a holder including creating a forward contract, the forward contract having a contract term extending from an issue date of the unit to a settlement date, the forward contract specifying a share delivery ratio for calculating a share delivery of issuer stock to the holder at said settlement date in exchange for a settlement amount; creating a note or preferred stock securing obligations of the holder under the forward contract, the note permitting the holder to convert the note into an amount of shares of issuer stock pursuant to a conversion formula; and issuing the forward contract and the note as a unit. Pursuant to some embodiments, the note is a contingent convertible debt instrument.

Some embodiments provide a system, method, apparatus, computer program code and means for administering a unit, including a processor, and a storage device in communication with the processor and storing instructions adapted to be executed by the processor to identify terms of a forward contract involving an issuer, a holder and an equity security, identify terms of a contingent convertible debt instrument involving the issuer, the holder and the equity security, and cause the issuance of a unit to the holder, the unit including the forward contract and the contingent convertible debt instrument.

Some embodiments provide a system, method, apparatus, computer program code, and means for method for issuing a unit to a holder and include: establishing a purchase contract portion of the unit, the purchase contract portion identifying a settlement price to be paid on a settlement date by the holder in exchange for a number of shares having a predetermined value; establishing a note portion of the unit, the note portion including terms identifying a maturity date, an initial principal amount, at least a first remarketing date, and at least one contingent feature; and issuing the unit to the holder. In some embodiments, some or all of the processing is performed using a computer.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF DRAWINGS

FIG. 1 is a block diagram of a transaction consistent with some embodiments.

FIG. 2 is a flow diagram illustrating an exemplary process for issuing a unit pursuant to some embodiments.

FIG. 3 is a block diagram of a unit administrator device pursuant to some embodiments.

### DETAILED DESCRIPTION

According to some embodiments, systems, methods, apparatus, computer program code, and means are provided for issuing a unit to a holder. Pursuant to some embodiments, a unit is issued which provides desirable economic benefits to an issuer of the unit that are generally unavailable in conjunction with existing hybrids. In some embodiments, desirable results are achieved through the issuance of units including a forward contract and a debt or preferred stock instrument (such as a contingent convertible debt instrument).

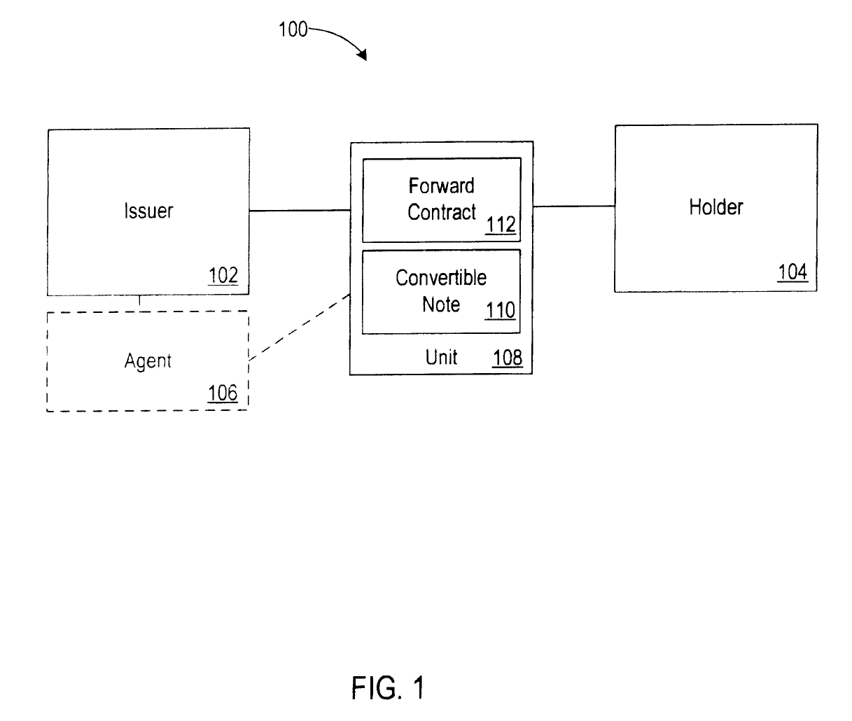

Features of embodiments will be described by first referring to FIG. 1, where a block diagram depicts a transaction 100 consistent with some embodiments. As shown, transaction 100 may involve the interaction of several entities or individuals: an issuer 102, a holder 104 and (in some embodiments) one or more agents 106. In particular, transaction 100 involves the issuance of a unit 108 to holder 104, where unit 108 consists of a forward contract 112 and a convertible note 110.

In some embodiments, issuer 102 is an entity having publicly traded shares of common stock, having a credit rating indicating that the entity is in generally sound financial condition and desiring to raise capital.

In some embodiments, issuer 102 is a financial institution regulated by the U.S. Federal Reserve (e.g., imposing certain regulatory requirements on the issuer's distribution of regulatory capital). Some embodiments relating to a regulated issuer 102 (and which allow such an issuer to treat mandatory units as “Tier 1” capital) are described in further detail in our co-pending, commonly-assigned U.S. Patent Application Serial No. 60/493,187, filed on Aug. 7, 2003.

In some embodiments, issuer 102 issues a unit directly to third parties. In some embodiments, a third party intermediary (such as one or more agents 106) may participate in the issuance of unit 108 to third parties. For example, agents 106 may be one or more underwriters, support companies, trustees, or the like (some of which will be discussed further below, some of which will be apparent to those skilled in the art).

In some embodiments, holder 104 may be, for example, an individual or entity desiring to invest in debt and equity securities associated with issuer 102. For example, in some embodiments, holder 104 may be an institutional investor such as a qualified institutional buyer.

Pursuant to some embodiments, unit 108 includes a forward contract 112 that includes terms obligating holder 104 to pay an amount (the “settlement price”) to issuer 102 at a particular date (the “settlement date”) in exchange for a variable number of shares of stock of issuer 102. The settlement price is, for example, an amount equal to the principal amount of the convertible note 110 portion of unit 108. The forward contract specifies that holder 104 is to receive an amount of stock of issuer 102 that initially (e.g., as of the “issue date” of the unit) has a value equal to the settlement price. The number of shares will be reduced if the value of the issuer's stock increases such that the holder never receives stock worth more than the settlement price. That is, forward contract 112 is structured to replicate the economics of purchasing puts (e.g., call options are effectively sold via the convertible debt portion of the unit). In some embodiments, the stock is common stock of issuer 102.

In some embodiments, issuer 102 is required to pay a contract fee to holder 104 in exchange for the holder's obligation to pay the settlement price at the settlement date. For example, the contract fee may be calculated as a percentage of the settlement amount. The fee may be paid quarterly or in other installments. In some embodiments, the settlement date is a date three (3) or four (4) years after the issue date of the unit (and, as will be described further below, is selected to have a term shorter than the term of convertible note 110).

Any of a number of different types or structures of forward contracts 112 may be used so long as some general attributes are provided. From the perspective of issuer 102, forward contract 112 is structured to be a nontaxable transaction in issuer stock, provide “equity credit” or guarantee the issuance of common stock at the settlement date, etc. For example, in some embodiments, from the perspective of holder 104, forward contract 112 may be structured to provide holder 104 with the full downside of any drops in stock price subsequent to the issue date; provide holder 104 with no participation in any appreciation in stock price subsequent to the issue date; and generate contract payments for holder 104 over some period (e.g., the payments may be required to be made during the course of the contract on some regular basis, such as quarterly or annually). In other embodiments, forward contract 112 may be structured so that holder 104 does not participate in the full downside of any drops in stock price. Other payout profiles may also be created.

As discussed above, forward contract 112 is issued as part of a unit in conjunction with convertible note 110. In particular, unit 108 includes convertible note 110 that is pledged to secure the holder's obligation to pay the settlement price under forward contract 112. Convertible note 110 is structured to allow holder 104 to elect to convert the note to shares of stock of issuer 102. Convertible note 110 also specifies a predetermined issue price and a principal amount (which may be subjected to an upward adjustment in the event there is an interest adjustment, as discussed further below). Convertible note 110 also specifies a maturity date. The maturity date of convertible note 110 is selected to be later than the settlement date of forward contract 112. In some embodiments, the maturity date of convertible note 110 is significantly later than the settlement date of forward contract 112 (e.g., in one specific example, forward contract 112 is a three (3) year contract, while convertible note 110 is a 30-year note).

Convertible note 110 also includes a number of terms that define the conversion rights of holder 104. In general, holders participate in any upside of the issuer's stock via these conversion rights. For example, the note specifies an initial conversion premium and a conversion ratio that are used to determine the number of shares receivable per note. In some embodiments, convertible note 110 is issued with a conversion right that is initially out of the money on the issue date. As one specific example, convertible note 110 may be issued with a conversion right that is 50% out of the money on the issue date (that is, holder 104 is entitled to exchange or convert the note for common stock of issuer 102 that is worth, on the issue date, only two-thirds (⅔) of the issue price of the note). In general, however, embodiments may utilize any of a number of terms causing the note to be a “convertible” note (e.g., which provide holder 104 a right to convert the note into shares of common stock of the issuer at some conversion rate).

Convertible note 110 has a stated principal amount that initially equals the settlement price of forward contract 112. In some embodiments, the interest rate associated with the security is an “accretion rate” (i.e., any interest accruing on the note is added to the principal amount). In other embodiments, convertible note 110 is a security that pays cash interest. In some embodiments, because the conversion right is valuable, convertible note 110 is issued with a low initial interest rate (in some embodiments, as a zero-coupon, zero interest rate, instrument).

Pursuant to some embodiments, convertible note 110 includes a “contingent conversion” feature. That is, pursuant to some embodiments, one or more conditions are specified which identify the circumstances under which the holder's conversion right may be exercised (for example, a stock price above which the conversion right may be exercised).

Pursuant to some embodiments, convertible note 110 is a contingent payment debt instrument (e.g., as defined by the relevant local tax rules) and is structured to include terms that permit issuer 102 to take deductions at its straight debt rate (regardless of the actual stated coupon or yield on the note). For example, in some embodiments (e.g., such as embodiments issued pursuant or subject to U.S. laws), convertible note 110 may include one or more terms causing the note to comply with U.S. Federal Tax rules (e.g., such as the rules set forth in 26 C.F.R. §1.1275-4 regarding “Contingent Payment Debt Instruments” and as set forth in Internal Revenue Service Revenue Ruling 2002-31, the contents of each of which are incorporated herein by reference for all purposes) as they currently exist or as they may be modified from time to time. Those skilled in the art will appreciate that other jurisdictions may impose similar rules.

Convertible note 110 further specifies one or more remarketing dates. Preferably, a first remarketing date occurs a short period prior to (or around) the settlement date of forward contract 112. In an example where forward contract 112 is a three (3) year contract, the first remarketing date may be scheduled to occur three months prior to the settlement date (that is, 2 years and 9 months after the issue date of unit 108). As a further illustrative example where convertible note 110 is a 30-year note, additional remarketings may be scheduled to occur at the end of years five (5), 10, 15, 20, and 25. As yet a further illustrative example, the additional remarketings may be associated with cash pay or zero accreting instruments.

Other remarketing terms may also be specified, including, for example, convertible note 110 may specify that in connection with the first remarketing the interest rate must be reset (if at all) so that note 110 can be remarketed for a specified price (e.g., for at least 100.5% of “Treasury consideration,” (an amount of cash sufficient to purchase U.S. treasury securities that mature on or before the settlement date with a principal amount sufficient to fund the settlement price). Those skilled in the art will appreciate that other remarketing prices may also be provided (e.g., a price of 100% or 100.25% may be provided instead of 100.50%, etc.). Holder 104 may elect to participate in such remarketing or may elect to retain convertible note 110. In the latter case, the holder must satisfy any requirements to pledge substitute collateral (or any other requirements).

Convertible note 110 may be issued as a cash pay or zero-coupon note. Interest may accrue on a floating rate or on a fixed basis. Interest rate resets may cause the note to become a cash pay or zero-coupon note with a fixed or floating rate. As a particular illustrative example, convertible note 110 may be a zero-coupon note in which interest is accrued on a five (5)-year floating rate basis, consistent with the remarketing of convertible note 110. As another example, convertible note 110 may initially be a zero-coupon note, paying zero interest. The interest rate may be reset to cause the note to be a cash interest note (e.g., at one or more of the remarketing dates).

In some embodiments, the reset and remarketing mechanisms disclosed in our co-pending U.S. Patent Application Serial No. 60/493,187 may be used. For example, several remarketings may be scheduled which are “capped” (that is, the initial remarketings may be structured such that they have a reset rate which is capped). If the first of the scheduled capped remarketings is not successful, a second (and then a third, for example) are attempted within a relatively short period of time (e.g., each capped remarketing may be attempted several months after the last failed capped remarketing). The issuer may also be provided a right to attempt an “opportunistic” remarketing during some period if each of the scheduled capped remarketings fail. Finally, if the opportunistic remarketing fails (or is not attempted by the issuer), a scheduled uncapped remarketing may be performed. In this manner, it is highly likely that a remarketing will be successful. It is also likely that the remarketing will be successful in one of the capped remarketings, thereby ensuring that the reset rate is controlled. Other reset and remarketing provisions and techniques may also be used in conjunction with embodiments disclosed herein.

Although convertible note 110 and forward contract 112 are issued as a unit, in some situations holder 104 may act to separate the note 110 from the forward contract 112. Holder 104 may be permitted to separate convertible note 110 from the forward contract 112 by pledging substitute collateral (e.g., U.S. Treasury securities) prior to the settlement date of forward contract 112. The substitute collateral will act to secure the holder's obligations under forward contract 112 and to separate convertible note 110 forward contract 112.

In some embodiments, convertible note 110 includes one or more terms that operate to generally discourage holder 104 from putting the note back to the issuer or performing an early conversion of the note. The inclusion of such terms generally allow convertible note 110 to qualify as a contingent debt instrument, as discussed briefly above. For example, convertible note 110 may include terms specifying one or more contingencies or events that: (a) cause an interest adjustment to occur; and/or (b) cause contingent cash interest to be paid. For example, in some embodiments, convertible note 110 includes terms specifying that additional contingent interest will be paid starting some period of time after the issue date of the note (generally following the expiration of the non-call period).

As a particular example where the settlement date is three (3) years after the issue date, additional contingent interest may be paid under specified circumstances starting five (5) years after the issue date. In some embodiments, the additional contingent interest paid is selected to be relatively significant. In this manner, holder 104 is encouraged to continue to hold the note rather than converting the note.

At some point, holder 104 may elect to perform a conversion of convertible note 110. To satisfy conversion, issuer 102 will deliver to holder 104 an amount of cash equal to the accreted principal amount of convertible note 110 and shares of common stock (or cash) with a value equal to the remaining conversion value of the note.

Pursuant to some embodiments of the present invention, convertible note 110 is further structured to provide an additional distribution of warrants at a specified date (e.g., at year five (5) in some embodiments). For example, holder 104 automatically may receive a distribution of warrants at year five (5) if the stock price is greater than the strike price on the warrants.

In this manner, embodiments provide benefits to both parties. For example, (in addition to the benefits associated with the forward discussed above) issuer 102 is entitled to deduct interest accruing on convertible note 110 at the single fixed rate at which issuer 102 could issue a comparable fixed-rate, non-convertible zero-coupon note with a similar maturity and having similar terms.

A number of benefits accrue to holder 104 as well. For example, after the settlement date, holder 104 takes no downside of decreases in value of the stock of issuer 102. In some embodiments, holder 104 may receive partial upside of common after warrants are distributed. Holder 104 may also benefit from additional interest if the issuer's stock rises a predetermined amount. Further, holder 104 benefits from any interest paid pursuant to the note. Those skilled in the art will, upon reading this disclosure, recognize other benefits to both holder 104 and issuer 102.

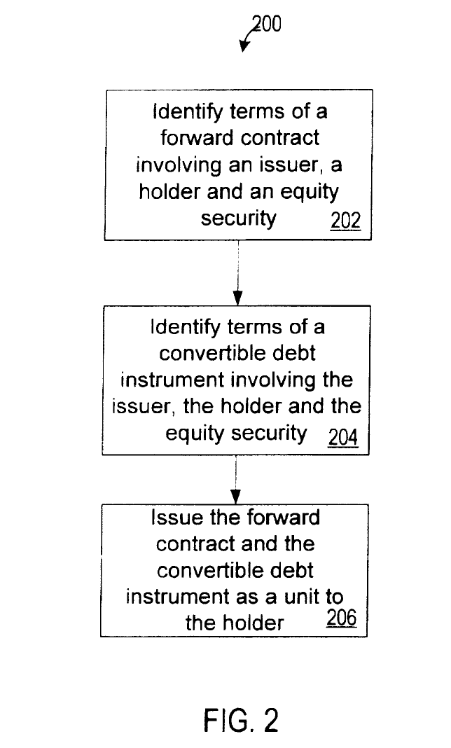

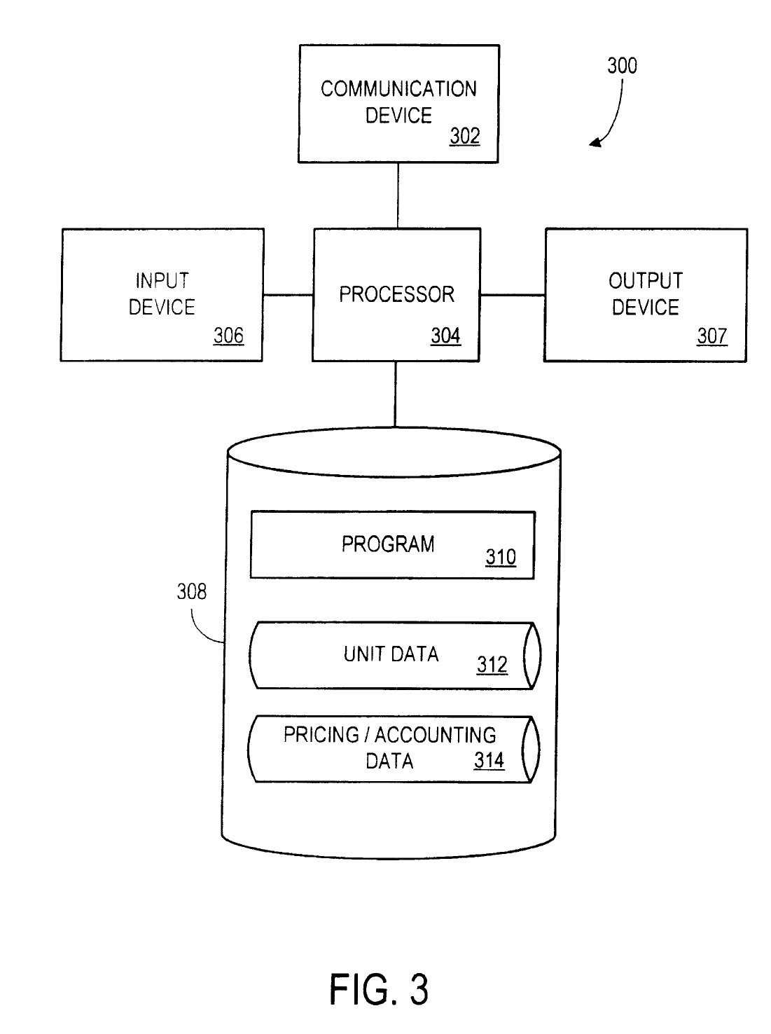

Further features of some embodiments will now be described by reference to FIG. 2 in which a flow diagram is presented depicting a transaction process 200 pursuant to some embodiments. Each of the process blocks of the flow diagram of FIG. 2 (and other process steps discussed herein) may be performed in any reasonable order and need not be performed in the sequence shown. In some embodiments, some or all of the processing of transaction process 200 may be performed using one or more computing devices configured to perform the processing described herein. For example, as will be described in further detail below, some or all of the processing may be performed using a unit administrator device 300 such as the device depicted in FIG. 3.

Processing associated with FIG. 2 will be described in conjunction with an illustrative example. In the illustrative example, a large public company (referred to as “ABC”) wishes to utilize features of embodiments of the present invention to issue a unit (to raise capital, for example) to an institutional investor (referred to in this illustrative example as “XYZ”) desiring to invest in ABC stock. That is, using the terminology introduced in FIG. 1 above, ABC is acting as issuer 102 and XYZ is acting as holder 104. ABC is a large corporation with a strong credit rating, and XYZ is a qualified institutional investor. At the time of issuance of the unit (on Feb. 15, 2004) ABC's stock price is $25.00. Those skilled in the art will appreciate that a number of units may be sold to one or more holders. In the illustrative example, ABC has chosen to issue 1 million units having an issue price of $1,000 per unit, generating total proceeds (before any offering expenses) of $1 billion.

Transaction process 200 begins at 202 where the parties interact to identify terms of a forward contract involving an issuer, a holder and an equity security. In the illustrative example, processing at 202 includes identifying terms of a forward contract involving ABC, XYZ and common stock of ABC. In this example, the settlement price on the forward contract is $1,000 and there are 1 million forward contracts. ABC does not receive any current proceeds from the forward contract but will receive total proceeds of $1 billion on the settlement date.

In the example transaction, the forward contract is structured to have a three (3) year term (that is, the settlement date is Feb. 15, 2007). The forward contract also specifies that ABC is to make quarterly contract payments to XYZ at an annual contract payment rate of 7.00%. The forward contract further specifies a settlement rate indicating that XYZ is to receive shares at the settlement date as follows: (1) if ABC's stock price on the settlement date is below the initial stock price of $25.00, XYZ will receive 40 shares ($1,000/$25=40); and (2) if ABC's stock price on the settlement date is above the initial stock price of $25.00, XYZ will receive a number of shares with a value equal to $1,000. That is, (at least with respect to the terms of the forward contract) XYZ is exposed to all of the downside associated with a drop in ABC's stock price, and does not benefit from any of the upside which may be associated with increases in ABC's stock price.

The terms specified at 202 may also include terms identifying one or more forms of collateral deemed acceptable, one of which is the second portion of the unit: the convertible note (discussed below in conjunction with 204). In this illustrative example, the parties also specify that U.S. Treasury securities maturing for $1,000 (the settlement price for each forward contract) on the settlement date are acceptable as collateral. The parties may specify further terms as needed to create an enforceable forward contract.

Process 200 continues at 204 where the parties act to identify terms of a convertible debt instrument involving the issuer, the holder and the equity security. In the illustrative example, 204 may include interaction between ABC and XYZ to identify terms of a convertible debt instrument allowing XYZ to convert the instrument into shares of ABC common stock. The legal form of the note, in the illustrative example, is senior or subordinated debentures of ABC having a maturity of Feb. 15, 2034 (that is, the note is a 30-year note). The issue price per debenture is the same as the settlement price per forward contract ($1,000) and the number of debentures is 1 million (the same as the number of forward contracts), for total initial proceeds of $1 billion. The note is callable by ABC, beginning after five (5) years.

The note is selected, in this particular example, to have a fixed coupon with zero accretion for the first 2.75 years (to the first remarketing date, which is a “coupon rate reset and debenture remarketing” date). The initial coupon rate is 0.00%. The coupon rate may be reset, and the debenture remarketed, at year 2.75. At this date, the coupon rate will be reset so that debentures can be remarketed for at least 100.5% of the price of U.S. Treasury securities that mature on or before the settlement date with a principal amount sufficient to fund the settlement price and the quarterly coupon on the convertible note due on the settlement date (based on the initial coupon rate). The coupon rate cannot be reset below zero, and the debentures are puttable by holders if they cannot be remarketed.

If the convertible debentures are out of the money (i.e., the stock price is less than the conversion price) at the end of year five (5) the debenture will be remarketed. The interest rate will be reset so that the debentures can be remarketed for at least the accreted principal amount (in this example, $1,000) in year five (5). Here, the interest rate will be an accretion rate, as the debentures will be remarketed as zero-coupon debentures (although in other examples the debentures could be remarketed with a fixed coupon). In connection with the remarketing, the conversion rate on the debentures may be reset such that the conversion price represents a specified premium (e.g., 200%) to the then-current stock price or the conversion right may be eliminated. Further remarketing dates occur at the end of years 10, 15, 20 and 25 where the interest rate is reset so that the debentures can be remarketed for at least the accreted principal amount in those years. For each of these resets, the interest rate cannot be reset below zero, and the debentures are puttable if the debentures cannot be remarketed.

Processing at 204 includes identifying other terms associated with the note. For example, the initial stock price of ABC common stock is identified. In this illustrative example, the initial stock price as of the issue date is $25.00. The note specifies an initial share conversion premium of 50%, resulting in an initial share conversion price of $37.50 and a share conversion ratio of 26.667 shares (calculated as the issue price divided by the initial share conversion price). The note also specifies a contingent payment threshold of 120% of the accreted principal amount. If XYZ (the holder) elects to convert, it may do so by surrendering the debenture, provided any conditions for conversion have been satisfied. The issuer (ABC) will deliver to XYZ cash with a value equal to the accreted principal amount and, has the option to provide shares, cash or any mix of shares and cash for any value above the accreted principal amount.

Further, in this illustrative example, the note specifies a contingent warrant which is distributed to the holder if the year five (5) stock price is greater than the initial share conversion price. If this occurs, the holder receives three (3) month common stock purchase warrants for 13.333 shares, and the principal amount is reduced to $950. That is, XYZ receives an additional distribution of ABC shares (via warrants) when the price of ABC stock rises above the strike price on the warrants. In other examples, XYZ may realize the value of the additional warrants through an adjustment to the conversion rate, rather than as a distribution of the warrants.

In general, the note is structured to ensure that the note is treated as a contingent payment debt instrument under the applicable laws of the jurisdiction in which the note is issued (e.g., a note issued in the U.S. may be structured to ensure that it is in compliance with IRS Revenue Rulings 2002-31 and 2003-97, etc.). In embodiments such as the illustrative example where warrants are issued in year five (5), the expected tax treatment is that the issuer may deduct the value of the warrants in year five (5) as a contingent payment.

In embodiments (such as this illustrative example) that utilize warrants, terms of the warrants may be specified. In this illustrative example, one warrant may be associated with each debenture and provide a maturity of three (3) months after issuance of the warrant (in year five (5)). Each warrant has a specified number of shares (here, 13.333), an initial stock price (here, $25.00), a warrant exercise premium (here, 50%), a strike price per share ($37.50 in this example), and a strike price per warrant ($500 in this example). The warrant may also include terms specifying acceptable forms of settlement. In the example, the issuer (ABC) is given the option to select acceptable forms of payment from among: net-share settlement; cash settlement; gross physical settlement (provided the issuer has the effective registration statement for the common stock); or any combination of these forms of settlement.

Referring again to FIG. 2, once the terms of the convertible note and the forward contract are identified and agreed upon, the process continues at 206 where the unit is issued to XYZ (the holder in the illustrative example) in exchange for a payment. Once issued, the parties exercise their rights and obligations under the agreements as described above (e.g., ABC pays a contract fee under the forward contract to XYZ; XYZ performs its settlement obligations under the forward; etc.).

In some embodiments, units issued pursuant to embodiments disclosed herein provide the issuer with a net theoretical value (NTV) equal to a substantial portion of the net proceeds (for example, in the example set forth above, ABC may enjoy a NTV of approximately 20% of the proceeds). As a simple comparison, the NTV associated with an issuance of straight equity is 0%. Many previous mandatory units result in a negative NTV. Other benefits also accrue. For example, ABC may enjoy a lower cost of capital associated with the issuance of the unit as described herein than for issuance of most previous mandatory units.

To further illustrate features of some embodiments, a further example will now be presented to illustrate processing during the first five (5) years of a transaction pursuant to some embodiments. In the example, a unit consisting of (a) 30-year contingent convertible debt, and (b) a three (3) year forward contract is issued. The unit has a yield of 7.00%, a convertible debt coupon of 0%, contract fees of 7.00% and a conversion premium of 20%. The unit is issued to a holder.

At year 2¾, (the reset and remarketing date), the interest rate on the convertible debt portion is reset to the issuer's borrowing rate for convertible debt, with an effective maturity of 2¼ years (coinciding with the year five (5) call date). Depending on the issuer's stock price (and value of embedded options), this rate may be significantly less than the issuer's straight debt rate. If the issuer's stock has appreciated significantly, the convertible debt may be remarketed at a substantial premium.

At year three (3), shares are issued to holders pursuant to the terms of the forward contract. For example, shares may be issued in the following ratios (where the dollar amount represents the issuer's stock price at year three (3)): $90 (1.000), $110 (0.9091), $130 (0.7692), or $150 (0.6667).

At year five (5), shares are issued to investors pursuant to the terms of the convertible debt portion (assuming that there is conversion, where the issuer delivers principal amount in cash and an “in the money” amount in stock). For example, shares may be issued in the following ratios (where the dollar amount represents the issuer's stock price at year five (5)): $90 (none), $110 (none), $130 (0.0641), and $150 (0.1667). In this manner, holders participate in any upside of the issuer's stock via terms of the convertible debt portion of the unit.

As discussed above, in some embodiments, additional embedded warrants may be a part of the convertible debt portion of the unit (e.g., the convertible debt may be structured as an “adjustable resettable convertible”). For example, the issuer can increase the conversion premium (without increasing the coupon/yield) by embedding additional options in the convertible debt portion of the unit. As discussed above, holders may realize the value of the additional warrants in several ways: (a) via distribution of the additional warrants at the first put/call date (year five (5) in the above examples), or (b) via adjustment to the conversion rate (where the conversion rate is increased to reflect the intrinsic value of the warrants, as though they were net-share settled).

A further example will now be provided, illustrating features of embodiments in which the value of the additional warrants is realized via distribution of the additional warrants at year five (5). In the example, the issuer issues a unit in which the convertible debt portion has a “base conversion price” of $160 (e.g., a base conversion rate of 6.25 shares). The convertible debt portion contains additional embedded warrants struck at the base conversion price (e.g., 7.5 additional warrants struck at $160, for a leverage ratio of 2.2×). At a first call date associated with the unit (e.g., at year five (5)), if the issuer's stock price is greater than the strike price of the warrants, (a) holders receive additional warrants (with a three-month life), (b) the base conversion rate remains unchanged (e.g., remains at 6.25 shares), and (c) the principal amount of the convertible debt portion is reduced (e.g., by $[50]) to reflect distribution of the extra warrants.

A further example will now be provided, illustrating features of embodiments in which the value of the additional warrants is realized via adjustment to the conversion rate. In the example, the issuer issues a unit in which the convertible debt portion with a “base conversion price” of $150 (e.g., a base conversion rate of 6.25 shares). The convertible debt portion further contains additional embedded options struck at the base conversion price (e.g., 7.5 additional warrants struck at $160). If the issuer's stock is above the base conversion price, the holders receive additional shares reflecting net-share settlement of the additional embedded options. In operation, as an example, if the issuer's stock is at the conversion price, the conversion rate is the base conversion rate is 6.25 shares. If the issuer's stock is above the conversion price, the conversion rate is equal to the base conversion rate+a number of additional warrants*((stock price conversion price)/stock price)). For example, if at year five (5), the issuers stock price is less than $160, then there is no conversion. If the issuer's stock price is $160, then the conversion rate is equal to 6.25 shares. If the issuer's stock price is $220, then the conversion rate is equal to 8.30 shares (6.25 base shares plus 2.05 additional shares). A maximum number of shares may be set. These examples are for illustrative purposes only; those skilled in the art will appreciate that a number of terms consistent with embodiments disclosed herein may be utilized.

Pursuant to some embodiment, some or all of the processes of FIG. 2 may be performed using one or more computing devices. Similarly, any of the participants (such as the issuer, the holder, or the agent) may utilize one or more computing devices to evaluate, price, administer, or manage units issued pursuant to embodiments described herein.

For example, referring now to FIG. 3, a computing device such as device 300 may be utilized. In some embodiments, device 300 is operated by one or more unit administrators acting to assist in, or direct the issuance of units pursuant to embodiments disclosed herein. For example, in some embodiments, device 300 is operated by, or on behalf of, an issuer to price and identify terms associated with the issuance of units. As another example, in some embodiments, device 300 may be operated by, or on behalf of, a remarketing agent to assist in the performance of one or more remarketings pursuant to embodiments of the present invention. As other examples, device 300 may be operated by, or on behalf of, a holder, an agent, or other participant in a transaction involving units as described herein.

As depicted, device 300 includes a computer processor 304 operatively coupled to a communication device 302, a storage device 308, an input device 306 and an output device 307. Communication device 302 may be used to facilitate communication with, for example, other devices and other participants (such as, for example, devices operated by holders, issuers, agents, market data providers, etc.) Input device 306 may comprise, for example, one or more devices used to input data and information, such as, for example: a keyboard, a keypad, a mouse or other pointing device, a microphone, knob or a switch, an infrared (IR) port, etc.

Output device 307 may comprise, for example, one or more devices used to output data and information, such as, for example: an IR port, a docking station, a display, a speaker, and/or a printer, etc.

Storage device 308 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

Storage device 308 stores one or more programs 310 or rule sets for controlling processor 304. Processor 308 performs instructions of program 310, and thereby operates in accordance with aspects of the present invention. In some embodiments, program 310 includes pricing rules used to evaluate or select terms associated with units issued pursuant to embodiments described herein. In some embodiments, program 310 includes rules used to identify the occurrence of events associated with units issued pursuant to the present invention (and to perform administration tasks relating to the occurrence of the events). In some embodiments, program 310 may be configured as a neural-network or other type of program using techniques known to those skilled in the art to achieve the functionality described herein.

Storage device 308 also stores one or more databases, including, for example, unit data 312, pricing and accounting data 314, etc. This information may be used, for example, to issue and/or administer units pursuant to embodiments disclosed herein. For example, unit data 312 may include information associated with the terms and conditions of units that have been issued and may be used to monitor and administer the units. Other data, programs, and rules may also be used in conjunction with embodiments disclosed herein.

For example, in some embodiments, device 300 may be operated to price, structure, or otherwise evaluate units issued (or to be issued) pursuant to the present invention. In such embodiments, device 300 may be in communication with, or have access to, a number of types of market data and information (e.g., via communication device 302). A user of device 300 may enter a number of terms associated with a unit and receive pricing and other data as outputs, allowing the user to price, structure or otherwise evaluate the desirability of a unit having particular terms.

For example, the user may input information such as an identification of the issuer stock associated with the unit and information associated with the structure of the unit (including settlement and maturity information, etc.). Device 300 may then operate to obtain information and data from different data sources. For example, device 300 may receive the following types of market data or information: a dividend yield on the issuer common stock; a historical volatility of the issuer common stock; implied volatilities for listed call and put option series of the issuer common stock; current interest rates; the issuer's credit rating; and rates achievable on nonconvertible instruments of the issuer. Further, information may also be obtained associated with similar data for previous issuers of optional and mandatory convertible instruments, and the yield and conversion premium and other terms achieved by these previous issuers of optional and mandatory convertibles.

Each of the items of information obtained by device 300 may then be used to price or evaluate terms of a unit. For example, if device 300 is operated by an issuer or issuer agent, the information may be used to structure terms of a unit for issuance. A prospective holder or other investor may operate device 300 to evaluate terms of a unit to determine if the terms result in a desirable investment to the holder. Other users may operate device 300 to evaluate terms of units issued pursuant to the present invention.

Although the present invention has been described with respect to a preferred embodiment thereof, those skilled in the art will note that various substitutions may be made to those embodiments described herein without departing from the spirit and scope of the present invention.

1. A method for issuing a unit to a holder, comprising:
creating a forward contract, the forward contract having a contract term extending from an issue date of said unit to a settlement date, said forward contract specifying a settlement rate for calculating a share delivery of issuer stock to said holder at said settlement date in exchange for a settlement amount;
creating a note securing obligations of said holder under said forward contract, said note permitting said holder to convert said note into an amount of shares of issuer stock pursuant to a specified conversion formula; and
issuing said forward contract and said note as a unit.

2. The method of claim 1, wherein said note is at least one of: a convertible debt instrument, a contingent convertible debt instrument, a convertible preferred instrument, a preferred stock instrument, and a fixed income instrument.

3. The method of claim 1, wherein said forward contract obligates said issuer to pay a contract fee to said holder during said contract term.

4. The method of claim 3, wherein said contract fee is specified as an annual contract payment rate paid quarterly during said term.

5. The method of claim 1, wherein said note has a maturity date, said maturity date occuring after said settlement date.

6. The method of claim 5, wherein said settlement date is less than or equal to about four years after said issue date.

7. The method of claim 1, wherein said conversion formula specifies an initial share price, an initial share conversion price, an initial share conversion premium, and a share conversion ratio.

8. The method of claim 1, wherein said note is a contingent payment debt instrument for tax purposes.

9. The method of claim 8, wherein said contingent note includes a contingency event occurring after said settlement date, said contingency event causing said holder to receive an amount of contingent interest if the trading price of the note is greater than a specified percentage of the accreted principal amount of said note.

10. The method of claim 9, wherein said contingency event causes a distribution of a number of warrants.

11. The method of claim 8, wherein said contingent note includes the distribution of additional warrants at a first call date associated with said note.

12. The method of claim 11, wherein said additional warrants are distributed if a share price of said issuer stock has increased above a predetermined amount since said issue date.

13. The method of claim 8, wherein said contingent note includes at least one of an interest adjustment mechanism and a contingent cash interest mechanism.

14. The method of claim 1, wherein said note further includes an issuer call option arising on a specified date prior to a maturity of said note.

15. The method of claim 1, wherein said note further includes a first remarketing scheduled on a first remarketing date occurring prior to said settlement date.

16. The method of claim 15, wherein said first remarketing is a capped remarketing.

17. The method of claim 16, wherein said note further includes at least a second capped remarketing scheduled after said first remarketing date.

18. The method of claim 17, wherein said note further includes an opportunistic remarketing period after said settlement date and during which said issuer can elect to cap a remarketing or not.

19. The method of claim 18, wherein said note further includes an uncapped remarketing scheduled after said opportunistic remarketing period.

20. The method of claim 1, wherein said note is at least one of a zero coupon note and a note having a low initial interest accretion rate.

21. The method of claim 1, wherein said forward contract specifying that said holder never receives an amount of issuer stock worth more than said settlement amount.

22. A unit administration system, comprising:
a processor; and
a storage device in communication with said processor and storing instructions adapted to be executed by said processor to:
identify terms of a forward contract involving an issuer, a holder and an equity security;
identify terms of a contingent convertible debt instrument involving said issuer, said holder and said equity security; and
cause the issuance of a unit to said holder, said unit including said forward contract and said contingent convertible debt instrument.

23. The unit administration system of claim 22, further comprising a communication device coupled to receive information from at least one of said issuer, said holder, and a market data source.

24. The method of claim 22, wherein said terms of said contingent convertible debt instrument include conversion terms requiring said issuer to deliver to said holder value equal to an accreted principal amount of said contingent convertible debt instrument and an amount of shares having a value equal to a remaining conversion value of said contingent convertible debt instrument.

25. A method for issuing a unit to a holder, comprising:
establishing a purchase contract portion of said unit, said purchase contract portion identifying a settlement price to be paid on a settlement date by said holder in exchange for a number of shares having a predetermined value;
establishing a note portion of said unit, said note portion including terms identifying a maturity date, an initial principal amount, at least a first remarketing date, and at least one contingent feature; and
issuing said unit to said holder.

26. The method of claim 24, said purchase contract portion further identifying a contract payment amount to be paid to said holder.

27. The method of claim 24, wherein at least one of said establishing a purchase contract portion, establishing said note portion and issuing said unit is performed using a computing device.

28. The method of claim 24, said note portion further comprising:
terms permitting said holder to convert said note portion into an amount of shares of issuer stock pursuant to a conversion formula.

29. The method of claim 24, wherein said at least one contingent feature is an additional distribution of warrants at a first call date if a share price is greater than a threshold amount.

30. A method for issuing a unit to a holder, comprising:
creating a forward contract obligating an issuer to pay a contract fee to the holder, said forward contract having a contract term and specifying a share delivery ratio for calculating a share delivery of issuer stock to said holder at an end of said contract term;
creating a convertible debt instrument securing obligations of said holder under said forward contract, said convertible debt instrument permitting said holder to convert said note into an amount of shares of issuer stock pursuant to a conversion formula, and specifying a contingent distribution of additional warrants at a first call date if a share price of said issuer stock is above a predetermined amount on said first call date; and
issuing said forward contract and said convertible debt instrument as a unit in exchange for a price.

31. The method of claim 29, wherein at least one of said creating a forward contract, creating a convertible debt instrument, and issuing said forward contract is performed using a computer.

32. A unit pricing device, comprising:
a processor;
a communication device coupled to receive market information from at least a first market data source; and
a storage device in communication with said processor and storing instructions adapted to be executed by said processor to:
receive data identifying terms of a proposed unit including data identifying terms of a forward contract involving an issuer and an equity security, and data identifying terms of a contingent convertible debt instrument involving said issuer and said equity security;
receive said market information from said market data source; and
generate, based on said market information and said terms of said proposed unit, pricing data associated with said proposed unit.

33. A computer-implemented method for issuing a unit to a holder, comprising:
receiving, in a computer, unit data, said unit data including data associated with an issuer stock, interest rate data, and yield data;
calculating, using said computer and based on said unit data, terms of said unit;
creating a forward contract having terms calculated by said computer, the forward contract having a contract term extending from an issue date of said unit to a settlement date, said forward contract specifying a settlement rate for calculating a share delivery of issuer stock to said holder at said settlement date in exchange for a settlement amount;
creating a note securing obligations of said holder under said forward contract, said note having terms calculated by said computer and permitting said holder to convert said note into an amount of shares of issuer stock pursuant to a specified conversion formula; and
issuing said forward contract and said note as a unit.
